(19) United States
(12) Patent Application Publication
(10) Pub. No.: US 2009/0281727 A1
(43) Pub. Date: Nov. 12, 2009

(54) CAR NAVIGATION SYSTEM

(75) Inventors: Yoshinori NAGATANI, Kanagawa (JP); Satoshi SHIGENAGA, Kyoto (JP); Shigeaki MIDO, Kanagawa (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 12/115,679

(22) Filed: May 6, 2008

(51) Int. Cl. G01C 21/36

(52) U.S. Cl. 701/210; 701/200

(57) ABSTRACT

A car navigation system capable of performing both real-time route guidance for a driver, and non-route-guidance display and operation of car navigation functions such as destination setting and vicinity searching for a non-driver, without necessitating a high-speed CPU or a high-performance drawing processing section. A display apparatus 200 is equipped with a CPU 210, an operating section 220, and drawing processing sections 230 and 240 corresponding to two display screens 250A and 250B, navigation-related processing is performed in a navigation apparatus 100, and drawing processing for the driver and drawing processing for a non-driver are executed independently by drawing processing sections 230 and 240 respectively of display apparatus 200. Functions are shared between navigation apparatus 100 and display apparatus 200.

### CROSS REFERENCE TO RELATED APPLICATIONS

The disclosure of Japanese Patent Application No. 2005-352540 filed on Dec. 6, 2005 including the specification, drawings and abstract is incorporated herein by reference in its entirety.

### BACKGROUND OF THE INVENTION

1. Field of the Invention

The present invention relates to a car navigation system, and more particularly to a car navigation system equipped with a display apparatus that can be seen by the driver and a display apparatus that can be seen by a passenger other than the driver (a non-driver).

2. Description of Related Art

Hitherto, a car navigation apparatus that is installed in a vehicle has been known. With a conventional car navigation system, the vehicle location is constantly detected and a map showing the vehicle location and the area around the vehicle location is displayed on a display screen. When a destination is set by inputting information such as an address or telephone number from an operating section, or directly specifying a particular spot from the map, a route from the vehicle location to the destination is found and displayed on the display screen, and while the vehicle is moving, route guidance is performed in real time according to the progress of the vehicle until the destination is reached. It is also possible to display information on stores/restaurants or parking lots in the vicinity of a particular spot on the map in icon form, and to display detailed store/restaurant information, parking lot vacancy information, and so forth.

With this kind of car navigation system, all car navigation functions can be executed while the vehicle is stationary, but while the vehicle is moving the functions that can be executed are limited to avoid the danger of the car navigation system being operated by the driver. However, it is useful for a passenger other than the driver, such as the front-seat passenger for example, to be able to carry out vicinity search, vicinity information display, and destination setting operations. Patent Document 1 (Unexamined Japanese Patent Publication No. 2005-55611) describes a technology whereby a viewing angle control shutter is provided on the front surface of a liquid crystal display panel constituting a display screen, and a non-driver sitting in the front passenger seat can enable destination setting, search, and suchlike operations through control of the video visible from the driver's seat and from the front passenger seat by driving this shutter.

However, with this kind of conventional dual-screen car navigation apparatus, the dual-screen display exerts a heavy load on the control section of the car navigation system, and problems such as the following arise.

For example, if a non-driver moves to enable a vicinity search, vicinity information display, destination setting, or suchlike operation on one display screen while route guidance is being performed for the driver on the other display screen, the processing load on the CPU of the navigation apparatus is extremely heavy. The above-described parallel processing is possible if a specially designed CPU with high processing capability is used, but such a CPU is expensive, and the use of such a CPU in a general-purpose car navigation apparatus that does not perform dual-screen display would not only be a case of over-specification but would require design modifications. There is thus a problem in terms of cost and versatility.

If a CPU installed in a current navigation apparatus is used, a heavy load is imposed by current location detection, route guidance, drawing processing by the drawing processing section, and so forth, resulting in problems of delays in processing necessary for real-time execution of vehicle location display, intersection guidance, and so forth, when performing route guidance, and the necessity of temporarily stopping route guidance when carrying out a vicinity search or change of destination. A further problem is algorithmic complexity due to the necessity of determining whether the driver or passenger has performed an operation, then determining whether the vehicle is stationary or moving, and finally performing processing corresponding to the operation.

### SUMMARY OF THE INVENTION

It is an object of the present invention to provide a car navigation system capable of performing both real-time route guidance for a driver, and non-route-guidance display and operation of car navigation functions such as destination setting and vicinity searching for a non-driver, without necessitating a high-speed CPU or a high-performance drawing processing section.

According to an aspect of the invention, a car navigation system includes a display apparatus and a navigation apparatus having a control section that executes a processing program for implementing a navigation function; wherein the navigation apparatus is equipped with a route guidance information creation section that creates route guidance information using sensor information and a route information database, and a first drawing processing section that performs drawing processing for navigation including a map based on created route guidance information; and the display apparatus is equipped with an operating section that operates destination setting or searching, a related information creation section that creates related information relating to route guidance based on an operation by means of the operating section and information from the navigation apparatus, and a second drawing processing section that performs drawing processing that converts to graphic form related information including a menu screen based on created related information.

### BRIEF DESCRIPTION OF THE DRAWINGS

FIG. 1 is a block diagram showing the configuration of a car navigation system according to Embodiment 1 of the present invention;

FIG. 2 is a drawing showing a schematic representation of display screens of a display panel of a display apparatus of a car navigation system according to above Embodiment 1;

FIG. 3 is a drawing showing the configuration of a drawing processing section of a display apparatus of a car navigation system according to above Embodiment 1;

FIG. 4 is a schematic diagram explaining a display screen of a display apparatus of a car navigation system according to above Embodiment 1;

FIG. 5 is a drawing showing a display screen viewed from the driver's side when moving of a display apparatus of a car navigation system according to above Embodiment 1;

FIG. 6 is a drawing showing a display screen viewed by a non-driver of a car navigation system according to above Embodiment 1;

FIG. 7 is a block diagram showing the configuration of a car navigation system according to Embodiment 2 of the present invention;

FIG. 8 is a block diagram showing the configuration of a car navigation system according to Embodiment 3 of the present invention;

FIG. 9 is a block diagram showing the configuration of a car navigation system according to Embodiment 4 of the present invention; and

FIG. 10 is a block diagram showing the configuration of a car navigation system according to Embodiment 5 of the present invention.

### DETAILED DESCRIPTION OF THE PREFERRED EMBODIMENTS

With reference now to the accompanying drawings, embodiments of the present invention will be explained in detail below.

### Embodiment 1

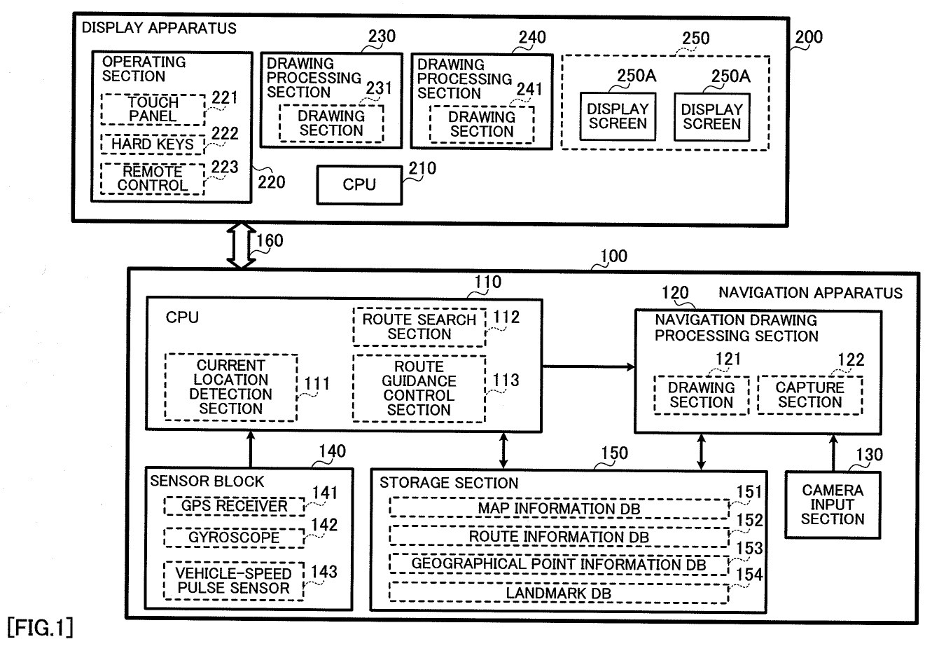

FIG. 1 is a block diagram showing the configuration of a car navigation system according to Embodiment 1 of the present invention. This embodiment is an example of application to a display apparatus provided on a dashboard as a display apparatus included in a car navigation system.

In FIG. 1, reference code 100 indicates a navigation apparatus, and reference code 200 indicates a display apparatus that is mounted on the dashboard between the driver's seat and front passenger seat and displays car navigation information. Navigation apparatus 100 and display apparatus 200 are connected via a flexible cable or suchlike external bus 160.

Navigation apparatus 100 is configured by means of a CPU 110, a navigation drawing processing section 120, a camera input section 130, a sensor block 140 that detects various kinds of information relating to car navigation, and a storage section 150 comprising semiconductor memory, an HDD, a magneto-optical disk, or the like.

CPU 110 performs overall control of navigation apparatus 100, and also executes a car navigation program indicated by a current location detection section 111 that detects the current location from a GPS (Global Positioning System) receiver 141, a route search section 112 that calculates an optimal route between an input starting point and destination, and a route guidance control section 113.

CPU 110 receives GPS receiver 141, gyroscope 142, vehicle-speed pulse sensor 143, and suchlike sensor information from sensor block 140 in real time, and detects the vehicle location from the GPS information, distance traveled, and so forth by means of current location detection section 111. Route search section 112 finds a route from the current location to the destination using a map information DB 151 and route information DB 152 of storage section 150, and route guidance is performed by means of route guidance control section 113. A geographical point information DB 153 in storage section 150 is used for destination setting. Navigation drawing processing section 120 performs 2D/3D map drawing, landmark drawing using a landmark DB 154 of storage section 150, and capture of images input from camera input section 130 by means of a capture section 122.

Navigation drawing processing section 120 is equipped with a drawing section 121 and capture section 122 that captures images taken by camera input section 130, and these comprise special circuitry for performing car navigation drawing processing at high speed.

Camera input section 130 is composed of a CCD (Charge Coupled Device: an area-type solid-state imaging device) camera and so forth, and inputs object image information.

Sensor block 140 includes GPS receiver 141, gyroscope 142, and vehicle-speed pulse sensor 143 that detects the vehicle speed. GPS receiver 141 receives a location information radio wave from a GPS satellite via a GPS antenna (not shown), and calculates two parameters, latitude and longitude, from the received location information and current location information. CPU 110 can determine the motion status using GPS receiver 141, gyroscope 142, vehicle-speed pulse sensor 143, an acceleration sensor, and so forth.

Storage section 150 includes map information database (DB) 151 comprising a DVD (Digital Versatile Disk) or the like holding map information, route information DB 152, geographical point information DB 153, and landmark DB 154. These databases are held on DVD or in a hard disk drive (HDD) or suchlike external storage apparatus.

Display apparatus 200 is mounted on the dashboard, for example, and performs navigation information display for the driver's seat, and vicinity search, vicinity information display, destination setting, and suchlike operations and display for a non-driver in the front passenger seat.

Display apparatus 200 is configured by means of a CPU 210, an operating section 220, a drawing processing section 230, a drawing processing section 240, and a display panel 250 that displays a display screen 250A and a display screen 250B. Although not shown in the figure, display apparatus 200 also has a loudspeaker. Operations by means of voice input can also be implemented by providing a microphone for voice input, a voice signal processing section that performs digital signal processing of a received signal and an input voice signal from the microphone, and a voice recognition section.

Operating section 220 is equipped with a touch panel 221 allowing touch input, hard keys 222 for performing input, mode switching, and the like, a remote control apparatus 223, and so forth, whose operation enables destination setting and vicinity searching to be carried out.

Drawing processing section 230 performs display screen 250A drawing processing by means of a drawing section 231, and drawing processing section 240 performs display screen 250B drawing by means of a drawing section 241.

Display panel 250 comprises a viewing angle control shutter (not shown), a dot matrix LCD display laminated with touch-input-capable touch panel 221, drivers, and so forth. For example, a route guidance display is shown on display screen 250A, and destination setting and vicinity search displays on display screen 250B. A display backlight can be turned on or flashed as necessary. The viewing angle control shutter has, in an area corresponding to one pixel, a polarizing plate, a microprism positioned over the polarizing plate, and a shutter cell comprising an electrode of ITO or the like, and each shutter cell displays the same image on the driver's seat side or the front passenger seat side, or on the driver's seat side and the front passenger seat side, through selective driving of one of first through third drive signals. Touch panel 221 is attached to the surface of display panel 250, and the effective area of touch panel 221 is equal to the entire display area of display panel 250. A user operation can be effected by touching touch panel 221.

It is also possible to connect a TV tuner, video camera, or the like, and display the video on display apparatus 200, or to connect a CD player or the like and output reproduced sound from the loudspeaker.

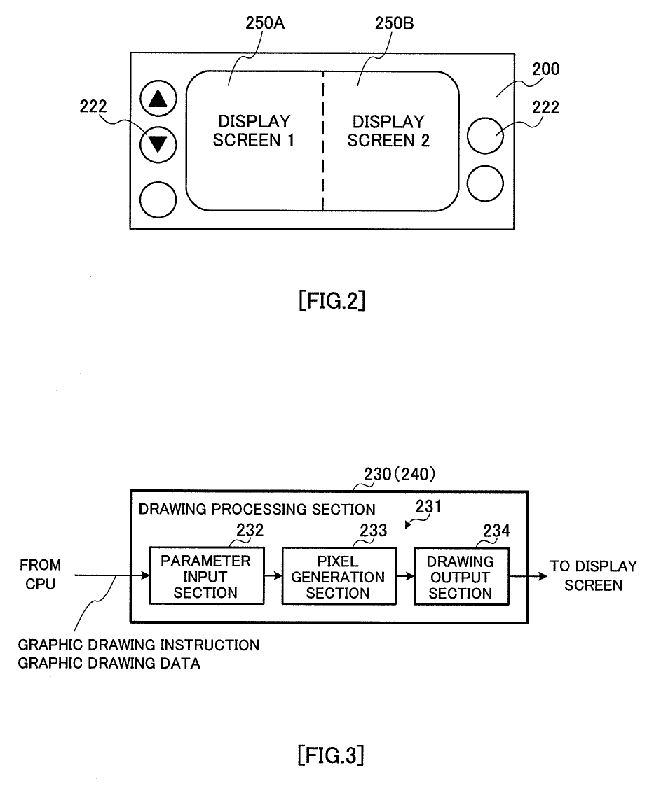

FIG. 2 is a drawing showing a schematic representation of the display screens of display panel 250 of display apparatus 200 described above.

Display panel 250 is equipped with the above-described viewing angle control shutter, and can display the same video on the driver's seat side or the front passenger seat side, or on the driver's seat side and the front passenger seat side.

When different displays are performed on the driver's side and non-driver's side, drawing is performed at half the resolution of the original image display for each of display screen 250A and display screen 250B as shown in FIG. 2. In FIG. 2, the split between display screen 250A and display screen 250B is at the halfway point of display panel 250, but this is simply a schematic diagram for the purpose of explanation, and in reality different images are displayed on the right side (driver's side) and left side (front passenger seat side) of the entire display panel 250 (although the horizontal resolution is halved). For example, in the case of an original 800×480-pixel image, there solution for separate display screens is 400×480 pixels.

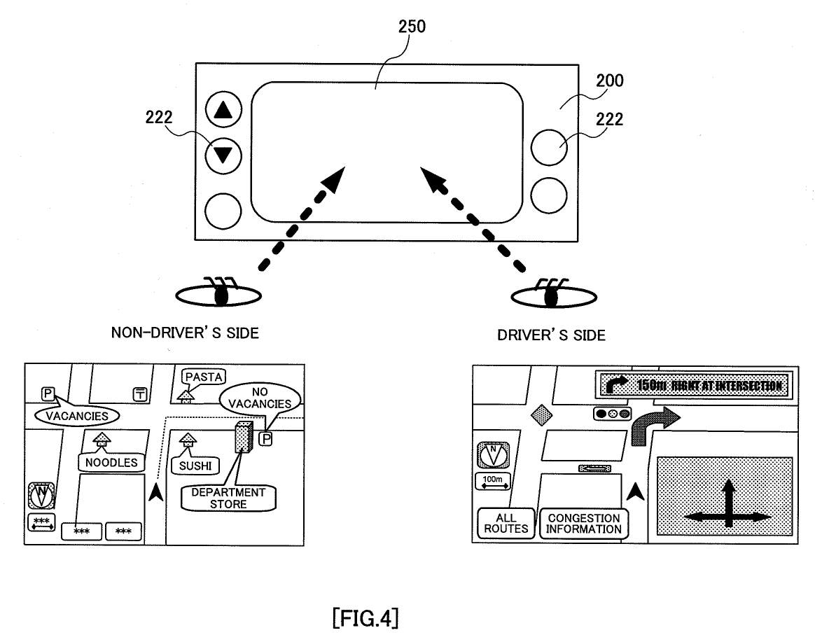

When the same display is performed on display apparatus 200 from the driver's side and non-driver's side, drawing can be performed at the full resolution of display apparatus 200 by performing a half display on each of display screen 250A and display screen 250B. Sample displays will be described later herein with reference to FIG. 4 through FIG. 6.

FIG. 3 is a drawing showing the configuration of drawing processing section 230 of above-described display apparatus 200, being a detailed block diagram of drawing section 231. Drawing processing section 240 that performs display screen 250A drawing processing and drawing processing section 230 that performs display screen 250B drawing processing have identical configurations, and therefore drawing processing section 230 is described here as representative of both.

In FIG. 3, drawing processing section 230 is configured by means of a parameter input section 232 that creates a parameter in accordance with a graphic drawing instruction from CPU 210, a pixel generation section 233 that generates a graphic to be drawn according to a generated parameter, and a drawing output section 234 that outputs generated drawing data.

Graphic drawing data from 210 is input to pixel generation section 233 via parameter input section 232. Parameter input section 232 creates a parameter in accordance with a graphic drawing instruction from CPU 210. Pixel generation section 233 generates a graphic to be drawn from graphic drawing data in accordance with a created parameter. Drawing output section 234 outputs generated drawing data to display screen 250A.

To be specific, drawing processing section 230 is composed of VRAM having a display area corresponding to display screen 250A of display panel 250 and a storage area for storing drawing data and bit map data, and a graphic LSI that performs display on display panel 250 by performing drawing in the VRAM display area. The graphic LSI is an element specialized for drawing processing, and also performs access control for the VRAM. On the other hand, CPU 210 is equipped with ROM storing a control program, a font, bit map (BMP) file, and so forth, used for image display, and performs operation control for the various sections of the apparatus, ROM access control, etc., in accordance with a program in ROM. This bit map file in the ROM is used to display many screens on display panel 250. The ROM also stores layout information used when bit map file data is transferred to and arranged in the VRAM storage area. Transferred bit map file data is stored in addresses in accordance with this layout information.

The operation of a car navigation system configured as described above will now be explained. First, the operation of navigation apparatus 100 and display apparatus 200 will be described.

[Operation of Navigation Apparatus 100]

CPU 110 of navigation apparatus 100 receives GPS receiver 141, gyroscope 142, vehicle-speed pulse sensor 143, and suchlike sensor information from sensor block 140 in real time, and detects the vehicle location by means of current location detection section 111. Route search section 112 finds a route from the current location to the destination using map information DB 151 and route information DB 152 of storage section 150, and route guidance is performed by means of route guidance control section 113. Geographical point information DB 153 in storage section 150 is used for destination setting. Navigation drawing processing section 120 performs 2D/3D map drawing, landmark drawing using landmark DB 154 of storage section 150, and capture of images input from camera input section 130 by means of capture section 122.

[Operation of Display Apparatus 200]

Display apparatus 200 is a dashboard-mounted car navigation display apparatus for the driver, and also a display apparatus for a non-driver sitting in the front passenger seat.

CPU 210 of display apparatus 200 does not accept system operation input during opening screen display, but accepts operation input after switching to normal screen display. Operation input is performed via touch panel 221 or the like according to various kinds of normal screen display contents.

When the vehicle is stationary, display apparatus 200 can be used for DVD and TV viewing, and allows destination setting and vicinity searching by means of touch panel 221, hard key 222, remote control apparatus 223, or suchlike operating section 220 operations. When the vehicle is moving, operations deemed to be dangerous while driving and operations relating to cessation of route guidance are restricted by CPU 210. Also, while a map showing the vehicle location and its vicinity is being displayed in real time, information up to the next intersection necessary for route guidance, local congestion information, one-way traffic and such like road information, information on accident black-spots, and so forth, is rendered by drawing sections 231 and 241 of drawing processing sections 230 and 240 and displayed on display screens 250A and 250B of display panel 250.

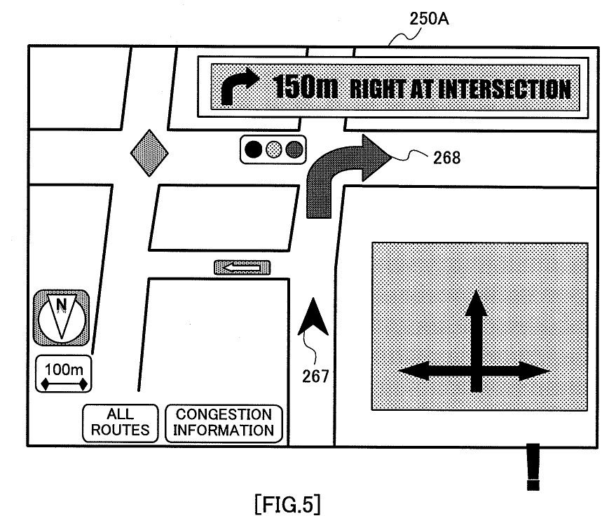

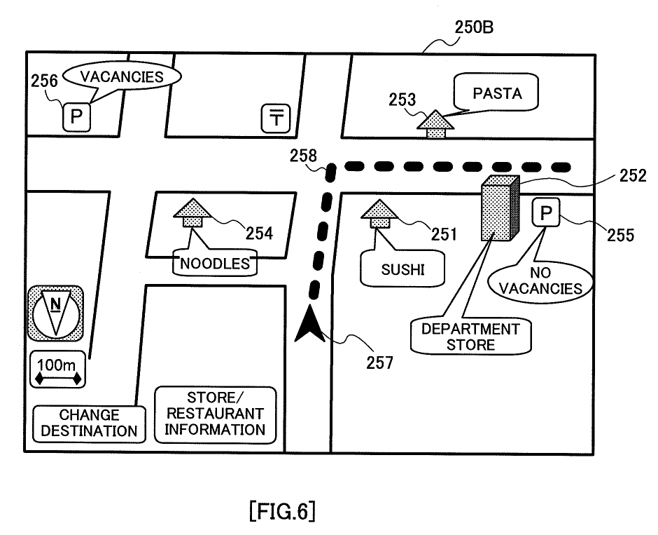

FIG. 4 is a schematic diagram explaining the display screen of car navigation system display apparatus 200, FIG. 5 is a drawing showing display screen 250A viewed from the driver's side when moving, and FIG. 6 is a drawing showing display screen 250B viewed by a non-driver.

In this car navigation system, display apparatus 200 has screen control performed by navigation apparatus 100 so one display screen appears as display screen 250A for the driver's use when viewed from the driver's side, and as display screen 250B for a non-driver's use when viewed from the front passenger seat side. Here, differentiation between a driver and non-driver is determined by whether the vehicle is moving or stationary. After driver/non-driver determination, an operation by means of operating section 220 from the non-driver's side is accepted, and drawing processing sections 230 and 240 perform drawing for their respective display screens.

When the vehicle is moving, display screen 250A is displayed on the driver's side as shown in FIG. 5. Reference number 267 indicates the location of the vehicle, and reference number 268 indicates route guidance. It is possible for the same display screen as on the driver's side also to be displayed on the non-driver's side by means of operating section 220. In this case, the horizontal resolution is twice that of single-side display.

Display screen 250B is displayed on the non-driver's side as shown in FIG. 6. On the non-driver's side, it is possible to watch a DVD or TV, and to perform destination setting or vicinity searching by means of an operating section 220 operation, regardless of whether the vehicle is stationary or moving. Also, local store/restaurant information, parking lot vacancy information, or the like required by a non-driver is rendered by drawing processing section 240 and displayed on display screen 250B. In FIG. 6, stores/restaurants 251 through 254 and parking lots 255 and 256 have been drawn. Reference number 257 indicates the location of the vehicle, and reference number 258 indicates predicted route information linked to driver's side route navigation 268 (see FIG. 5). When the vehicle is stationary, it is possible for the same display screen as on the non-driver's side also to be displayed on the driver's side by means of operating section 220. In this case, the horizontal resolution is twice that of single-side display.

Next, car navigation system operation will be described.

CPU 110 of navigation apparatus 100 calculates the vehicle's location and route based on vehicle location information from GPS receiver 141, vehicle orientation information from gyroscope 142, and vehicle speed information from vehicle-speed pulse sensor 143. Route search section 112 finds a route between the vehicle location and destination using route information DB 152, and route guidance control section 113 controls drawing processing sections 230 and 240 along this route. Drawing processing section 230 performs drawing using map information DB 151 and landmark DB 154. Also, drawing processing section 240 renders store/restaurant and parking lot information in a vicinity search using geographical point information DB 153, and captures camera input section 130 images by means of capture section 122.

In the case of drawing processing section 230 of display apparatus 200, display need only be performed for the driver, and therefore functions such as destination setting and vicinity searching are restricted while the vehicle is moving, and especially in route guidance information from navigation apparatus 100, additional information relating to route guidance for which urgency and immediacy are required, such as display of the distance to an intersection, congestion display, and accident black-spot display, is subjected to drawing processing in real time and is displayed on display screen 250A (see FIG. 5).

On the other hand, in the case of drawing processing section 240 of display apparatus 200, display need only be performed for a non-driver, and therefore differentiation between a stationary or moving state and so forth is unnecessary, and operations can be executed via operating section 220 at any time. Especially in vicinity map information from navigation apparatus 100, geographical point information for the vicinity of the vehicle location or the route to the destination, such as local store/restaurant information and parking lot information, is subjected to drawing processing and is displayed on display screen 250B (see FIG. 6).

As described above, according to Embodiment 1, display apparatus 200 is equipped with a CPU 210, operating section 220, and drawing processing sections 230 and 240 corresponding to two display screens 250A and 250B, navigation-related processing is performed in navigation apparatus 100, and furthermore drawing processing for the driver and drawing processing for a non-driver can be executed independently by drawing processing sections 230 and 240 respectively of display apparatus 200. That is to say, functions are shared between navigation apparatus 100 and display apparatus 200 so that navigation system route guidance is performed by navigation apparatus 100 and other functions by display apparatus 200, and processing in response to an operation via touch panel 221, hard keys 222, or remote control apparatus 223 of display apparatus 200 is completed in display apparatus 200.

The above-mentioned navigation function sharing between navigation apparatus 100 and display apparatus 200 will now be described in further detail. According to this embodiment, function sharing is implemented by having navigation drawing processing section 120 provided in navigation apparatus 100 perform drawing for navigation purposes, such as map drawing, and having drawing processing sections 230 and 240 provided in display apparatus 200 perform menu screen and suchlike drawing. Also, navigation drawing processing section 120 provided in navigation apparatus 100 displays roads and so forth, while drawing processing sections 230 and 240 provided in display apparatus 200 display separate information (store/restaurant information, parking lot information, and the like) customized for display screens 250A and 250B respectively. Since drawing processing for destination setting by means of operating section 220 and so forth is delegated to display apparatus 200, this function sharing enables algorithms for operations via the operating section to be simplified from the standpoint of CPU 110 of navigation apparatus 100. For the same reason, real-time route guidance can be performed for the driver while the vehicle is moving, while also allowing anon-driver in the front passenger seat or a rear passenger seat to watch a DVD or TV freely and operate car navigation functions such as destination setting or a vicinity search, without the need for a high-speed CPU or high-performance drawing processing.

### Embodiment 2

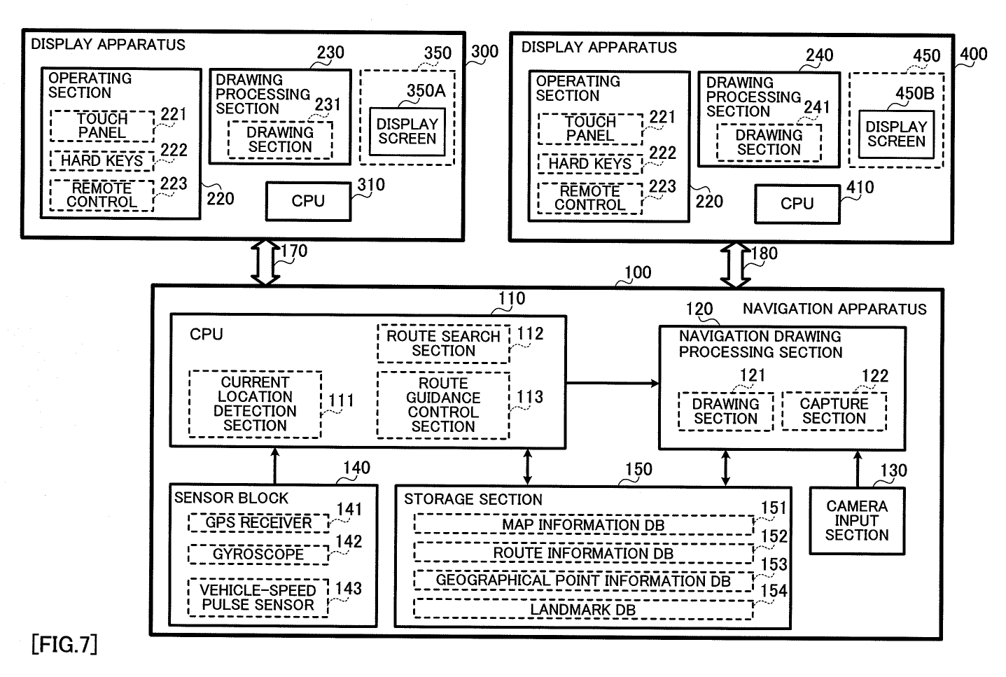

FIG. 7 is a block diagram showing the configuration of a car navigation system according to Embodiment 2 of the present invention. In the description of this embodiment, configuration parts identical to those in FIG. 1 are assigned the same reference codes as in FIG. 1, and duplicate descriptions are omitted.

In FIG. 7, reference code 100 indicates a navigation apparatus, reference code 300 indicates a display apparatus that is mounted on the dashboard between the driver's seat and front passenger seat and displays car navigation information, and reference code 400 indicates a display apparatus for a non-driver that is installed outside the field of view of the driver, such as on a rear seat, for example. Display apparatus 300 and display apparatus 400 are connected to navigation apparatus 100 via flexible cables or suchlike external buses 170 and 180 respectively.

Display apparatus 300 is mounted on the dashboard, and performs navigation information for the driver's seat, and vicinity search, vicinity information display, destination setting, and suchlike operations and display for a non-driver in the front passenger seat. Display apparatus 300 is configured by means of a CPU 310, an operating section 220, a drawing processing section 230, a drawing processing section 240, and a display panel 350 that displays a display screen 350A.

Display panel 350 comprises a dot matrix LCD display laminated with touch-input-capable touch panel 221, drivers, and so forth. Touch panel 221 is attached to the surface of display panel 350, and the effective area of touch panel 221 is equal to the entire display area of display panel 350. A user operation can be effected by touching touch panel 221.

Display apparatus 300 is a dashboard-mounted display apparatus for the driver, and when the vehicle is moving, operations deemed to be dangerous while driving and operations relating to cessation of route guidance are restricted by CPU 310. Also, while a map showing the vehicle location and its vicinity is being displayed in real time, information up to the next intersection necessary for route guidance, local congestion information, one-way traffic and suchlike road information, information on accident black-spots, and so forth, is rendered by drawing section 231 of drawing processing section 230 and displayed on display screen 350A. An example of display screen 350A displayed by driver's display apparatus 300 while the vehicle is moving is shown in FIG. 5.

Display apparatus 400 is a display apparatus for a non-driver, mounted on a rear seat, and is configured by means of a CPU 410, an operating section 220, a drawing processing section 240, and a display panel 450 that displays a display screen 450A. Although not shown in the figure, display apparatus 400 also has a loudspeaker. As with above-described display panel 350, display panel 450 comprises a dot matrix LCD display laminated with touch-input-capable touch panel 221, drivers, and so forth.

Display apparatus 400 is a display apparatus for a non-driver that is installed outside the field of view of the driver, such as on a rear seat, for example. In the case of display apparatus 400, it is possible to watch a DVD or TV, and to perform destination setting or vicinity searching by means of an operating section 220 operation, regardless of whether the vehicle is stationary or moving. Also, local store/restaurant information, parking lot vacancy information, or the like required by a non-driver is rendered by drawing processing section 240 and displayed on display screen 450B. An example of display screen 450B displayed by display apparatus 400 for non-driver use is shown in FIG. 6.

The operation of a car navigation system configured as described above will now be explained.

CPU 110 of navigation apparatus 100 calculates the vehicle's location and route based on vehicle location information from GPS receiver 141, vehicle orientation information from gyroscope 142, and vehicle speed information from vehicle-speed pulse sensor 143. Route search section 112 finds a route between the vehicle location and destination using route information DB 152, and route guidance control section 113 performs the following guidance control along this route. Navigation drawing processing section 120 performs drawing using map information DB 151 and landmark DB 154, renders store/restaurant and parking lot information in a vicinity search using geographical point information DB 153, and captures camera input section 130 images by means of capture section 122.

In the case of driver's side display apparatus 300, display need only be performed for the driver, and therefore functions such as destination setting and vicinity searching are restricted while the vehicle is moving, and especially in route guidance information from navigation apparatus 100, additional information relating to real-time route guidance, such as display of the distance to an intersection, congestion display, and accident black-spot display, is rendered by drawing section 231 of drawing processing section 230 and is displayed on display screen 350A of display panel 350.

In the case of rear-seat-mounted display apparatus 400, display need only be performed for a non-driver, and therefore differentiation between a stationary or moving state and so forth is unnecessary, and operations can be executed via operating section 220 at any time. Also, drawing section 241 of drawing processing section 240 renders vicinity map information, local store/restaurant information, parking lot information, geographical point information for the vicinity of the vehicle location or the route to the destination, and so forth, based on information from navigation apparatus 100, and displays it on display screen 450B of display panel 450.

According to Embodiment 2, navigation-related processing can be completed in navigation apparatus 100, processing for the driver can be completed in display apparatus 300, and processing for a non-driver can be completed in display apparatus 400, so that even when the vehicle is moving, a non-driver can perform a car navigation operation such as a destination search or vicinity guidance without interfering with real-time navigation for the driver.

### Embodiment 3

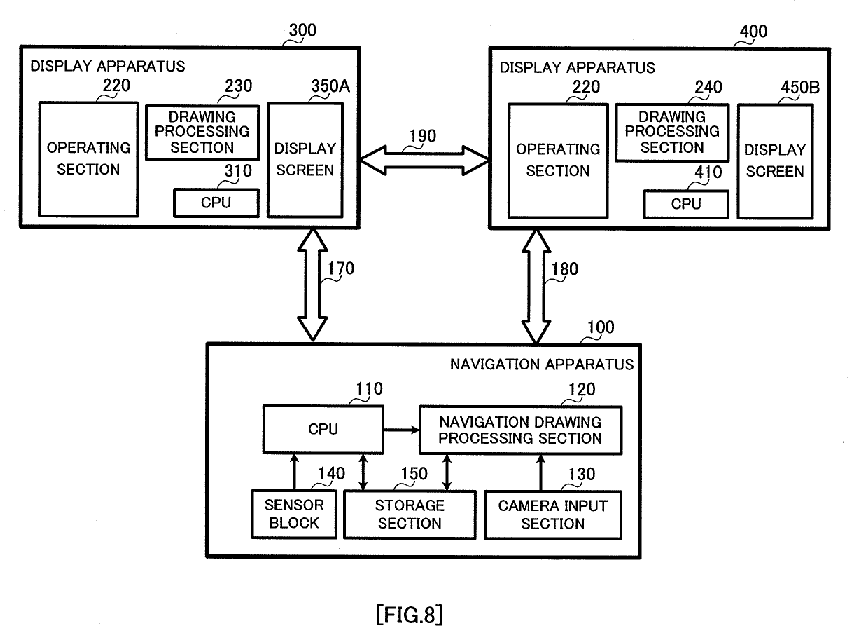

FIG. 8 is a block diagram showing the configuration of a car navigation system according to Embodiment 3 of the present invention. Configuration parts identical to those in FIG. 7 are assigned the same reference codes as in FIG. 7, and duplicate descriptions are omitted.

In FIG. 8, reference code 100 indicates a navigation apparatus, reference code 300 indicates a display apparatus that is mounted on the dashboard between the driver's seat and front passenger seat and displays car navigation information, and reference code 400 indicates a display apparatus for a non-driver that is installed outside the field of view of the driver, such as on a rear seat, for example.

Display apparatus 300 and display apparatus 400 are connected to navigation apparatus 100 via flexible cables or suchlike external buses 170 and 180 respectively, and display apparatus 300 and display apparatus 400 are connected to each other via a dedicated cable 190.

Display apparatus 300 and display apparatus 400 have a communication function, and transmit and receive data to/from each other via dedicated cable 190. The bidirectional communication function may be of any kind, but should preferably provide high-speed data communication that enables destination or suchlike information set via display apparatus 400, and DVD playback or suchlike image data, to be transferred to display apparatus 300 (reverse-direction transfer also being possible) a thigh-speed. As a simpler communication function, an Ethernet (registered trademark) system can be used that allows high-speed data transfer using a pair of signal lines.

As display apparatus 300 and display apparatus 400 can transmit and receive data between themselves by means of the communication function, the following kind of operation is also possible in addition to the operations of Embodiment 2.

A new destination set by a non-driver via display apparatus 400 while the vehicle is moving can be transferred to display apparatus 300 via dedicated cable 190 by means of the communication function between display apparatus 300 and display apparatus 400. In this case, since only the destination changes in display apparatus 300 while route guidance is continued, it is no longer necessary to stop the vehicle or temporarily interrupt route guidance when a new destination is introduced into route guidance. Thus, a change of destination can be carried out without stopping the vehicle or temporarily interrupting route guidance, and without placing a burden on the driver or interfering with driving.

### Embodiment 4

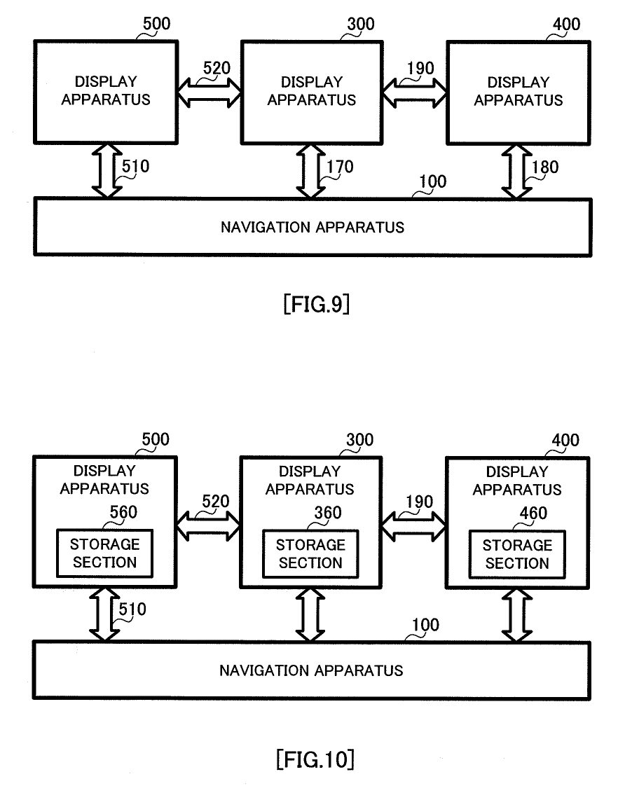

FIG. 9 is a block diagram showing the configuration of a car navigation system according to Embodiment 4 of the present invention. Configuration parts identical to those in FIG. 8 are assigned the same reference codes as in FIG. 8, and duplicate descriptions are omitted.

In FIG. 9, the car navigation system is further equipped with a display apparatus 500 for a non-driver. Display apparatus 500 has a communication function, is connected to navigation apparatus 100 via a flexible cable or suchlike external bus 510, and is furthermore connected to display apparatus 300 and display apparatus 400 via a dedicated cable 520.

Display apparatuses 400 and 500 for non-driver use may also be three or more in number according to the number of non-drivers. By means of this configuration, each non-driver can freely perform a local facility search by having a respective display apparatus 400/500.

### Embodiment 5

FIG. 10 is a block diagram showing the configuration of a car navigation system according to Embodiment 5 of the present invention. Configuration parts identical to those in FIG. 9 are assigned the same reference codes as in FIG. 9, and duplicate descriptions are omitted.

In FIG. 10, display apparatus 300 for the driver and display apparatuses 400 and 500 for non-drivers are equipped with storage sections 360, 460, and 560 respectively that allow the insertion of an external storage medium such as a CD or an SD card. In storage sections 360, 460, and 560, a database is constructed based on various kinds of information downloaded from media such as a CD or an SD card or via Internet or suchlike communication. The fact that display apparatuses 300, 400, and 500 have databases in storage sections 360, 460, and 560 respectively enables information on accident black-spots and congestion needed by the driver, and store/restaurant information, tourist information, and the like needed by a non-driver, to be held separately in display apparatuses 300, 400, and 500, and their displays to be customized.

The above descriptions are illustrations of preferred embodiments of the present invention, and the scope of the present invention is not limited to these. For example, in Embodiment 1 an example of a display apparatus to which a viewing angle control shutter is applied has been described, but a display panel of a similar but different type—such as a parallactic barrier type—may also be used. Also, the sample displays in FIG. 4 through FIG. 6 are only examples, and the displays may be of any kind.

In these embodiments, the term “car navigation system” has been used, but this is simply for convenience in describing the embodiments, and terms such as “car navigation apparatus”, “display apparatus” and the like may, of course, also be used.

The type, number, connection method, and so forth of circuit sections configuring an above-described car navigation apparatus are not limited to those in the above embodiments.

As described above, according to the present invention, in the control section of a navigation apparatus an algorithm for an operation from an operating section can be simplified, and a high-speed CPU and high-performance drawing processing section are not necessary, enabling cost reduction to be achieved, and enabling an existing navigation apparatus to be used as-is, with a resultant effect of excellent versatility.

Since various kinds of operation or destination setting and the like can be performed via a display apparatus, while a vehicle is moving it is possible for real-time route guidance to be performed for the driver while a non-driver sitting in the front passenger seat or a rear seat is able to freely watch a DVD or TV and operate car navigation functions such as destination setting and a vicinity search.

Therefore, a car navigation system according to the present invention is useful in terms of safety and convenience since it has a display apparatus for the driver's use and for a non-driver's use, and a non-driver can perform a car navigation operation such as a destination search or vicinity guidance without interfering with real-time navigation for the driver even when the vehicle is moving.

What is claimed is:

1. A car navigation system comprising:
a display apparatus; and
a navigation apparatus having a control section that executes a processing program for implementing a navigation function, wherein:
said navigation apparatus has:
a route guidance information creation section that creates route guidance information using sensor information and a route information database; and
a first drawing processing section that performs drawing processing for navigation including a map based on created route guidance information, and
said display apparatus has:
an operating section that operates destination setting or searching;
a related information creation section that creates related information relating to route guidance based on an operation by means of said operating section and information from said navigation apparatus; and
a second drawing processing section that performs drawing processing that converts to graphic form related information including a menu screen based on created related information.

2. The car navigation system according to claim 1, wherein said route guidance information includes vehicle location information and vicinity map information.

3. The car navigation system according to claim 1, wherein said related information is at least one of intersection information necessary for route guidance, congestion information, road information, accident black-spot information, store/restaurant information, or parking lot information.

4. The car navigation system according to claim 1, wherein said display apparatus is composed of a plurality of display apparatuses for driver and non-driver use.

5. The car navigation system according to claim 4, wherein:
said display apparatus for driver use displays information created by said first drawing processing section; and
said display apparatus for non-driver use displays said related information created by said second drawing processing section.

6. The car navigation system according to claim 5, wherein said display apparatus comprises a display panel capable of display by switching between display that can be seen from one or other of a first or second direction and display that can be seen from both a first and second direction.

7. The car navigation system according to claim 6, wherein:
information created by said first drawing processing section is displayed as display information of said first direction; and
said related information created by said second drawing processing section is displayed as display information of said second direction.

8. The car navigation system according to claim 1, wherein said display apparatus further comprises a determining section that determines whether an operation by means of said operating section is performed by a driver or a non-driver.

9. The car navigation system according to claim 8, wherein retrieval or setting of said related information is permitted when said operation by means of said operating section is determined to be by a non-driver.
